(19) United States
(12) Patent Application Publication
(10) Pub. No.: US 2026/0211611 A1
(43) Pub. Date: Jul. 23, 2026

(54) AUDIO COMMUNICATIONS SYSTEM

(71) Applicant: Cirrus Logic International Semiconductor Ltd., Edinburgh (GB)

(72) Inventors: Erich P. ZWYSSIG, Edinburgh (GB); Benjamin YOUNG, Edinburgh (GB); Pradeep SAMINATHAN, Edinburgh (GB)

(73) Assignee: Cirrus Logic International Semiconductor Ltd., Edinburgh (GB)

(21) Appl. No.: 19/447,383

(22) Filed: Jan. 13, 2026

Related U.S. Application Data
(60) Provisional application No. 63/746,315, filed on Jan. 17, 2025.

(30) Foreign Application Priority Data
Jan. 13, 2026 (GB) 2600697.3

(51) Int. Cl. G06F 3/16; H04J 3/06

(52) U.S. Cl. CPC G06F 3/162; H04J 3/0647

(57) ABSTRACT

An audio communication system comprising: a first audio device; and a second audio device coupled to the first audio device by a digital audio interface, wherein: the first audio device is configured to synchronise a frame start symbol of a first audio device output signal for transmission by the first audio device to the second audio device with a first frame synchronisation signal local to the first audio device; and the second audio device is configured to detect the frame start symbol of the first audio device output signal and synchronise a second frame synchronisation signal local to the second audio device to the first frame synchronisation signal based on detection of the frame start symbol.

### FIELD OF THE INVENTION

The present disclosure relates to an audio communication system.

### BACKGROUND

Digital audio interfaces are used to couple digital audio devices or integrated circuits together to permit the transmission of digital audio data from one device or integrated circuit to another.

Such interfaces typically include an audio data line for carrying audio data comprising a stream of serial data bits encoding one or more channels of audio data. The stream of serial data bits is divided into frames of audio data, each comprising a predefined number of bits.

In some applications, a plurality of audio devices, each providing one or more channels of audio data, can be coupled together in a daisy-chain arrangement using serial audio interfaces of the devices, to enable the transmission of frames of digital audio data from each of the plurality of devices to a processing device. For example, in a live performance setting, a plurality of microphones may each be coupled to or provided with a respective audio interface, and the audio interfaces may be coupled in a daisy-chain arrangement to a mixing desk. Each audio interface thus transmits frames of digital audio data representing signals output by its coupled microphone to the mixing desk over an audio network comprising the daisy-chained audio interfaces.

Serial audio interfaces such as ADAT (Alesis Digital Audio Tape), S/PDIF (Sony/Philips Digital Interface) and AES3 generally combine clock and data signals on a single wire. Such interfaces infer an audio sample clock in the data encoding scheme, and can require a phase-locked loop (PLL) or similar function in a receiver to obtain a low-jitter clock suitable for use with components such as a high-performance digital-to-analog converter (DAC), digital signal processor (DSP) or the like, which is synchronous with the serial data stream.

U.S. Pat. No. 7,948,405 describes a clocking scheme in which input data is stored in a first-in first-out buffer (FIFO) using a noisy clock recovered from input audio data, and the data is output using a clean clock derived from a crystal and a fractional-N PLL, where the PLL frequency is kept in synchronisation with the input data by keeping the FIFO fulness at 50%. Such a scheme guarantees that multiple devices are frequency locked while still generating high fidelity (HiFi) audio signals that are bit true to incoming audio signals.

US Patent Application Publication No. US2005/0220240 describes a scheme where an S/PDIF receiver generates a clean clock from a recovered input clock using a high-quality PLL, controlled by the status of the FIFO.

U.S. Pat. No. 6,208,671 describes an asynchronous sample rate converter using a rate detector.

The contents of U.S. Pat. No. 7,948,405, US Patent Application Publication No. US2005/0220240, and U.S. Pat. No. 6,208,671 are incorporated by reference herein.

FIG. 1 illustrates a system in which two audio interface devices are coupled together and frequency locked. The audio interface devices may be audio integrated circuits (ICs) for example.

In the system shown generally at 100 in FIG. 1, a first audio interface device 110a is configured as a transmitting device to transmit digital audio data to a second audio interface device 110b, which is identical to the first audio interface device 110a, over a digital audio interface such as an ADAT or S/PDIF interface.

The first and second audio interface devices 110a, 110b each include a first clock generation module 122, a receiver module 124, a clock and data recovery module 126, a first-in-first out buffer (FIFO) 128, a phase-locked loop (PLL) 130, a second clock generation module 132, a time division multiplexing (TDM) control module 134, a transmit module 136 and an asynchronous sample rate converter 140.

In the system 100 of FIG. 1, the first audio interface device 110a receives a first input data signal DIN1 comprising digital audio data to be transmitted to the second audio interface device 110b over the digital audio interface. The first input data signal DIN1 may comprise digital audio data from a first audio channel, e.g. digital audio data received from a first analog to digital converter (ADC) coupled to a first microphone.

The first clock generation module 122 of the first audio interface device 110a receives a base clock signal BCLK and a frame synchronisation signal FSYNC. Alternatively, if the first audio interface device 110a is a primary audio interface device, the base clock signal BCLK and the frame synchronisation signal FSYNC may be generated by the first audio interface device 110a, e.g. by the first clock generation module 122 of the first audio interface device 110a.

The frame synchronisation signal FSYNC is input to the PLL 130, which outputs a master system clock signal SYSCLK to the second clock generation module 132, which in turn outputs a clock signal derived from or based on the master system clock signal SYSCLK to the transmit module 136.

The first input data signal DIN1 is output to the TDM control module 134. The TDM control module 134 is configured to control time domain multiplexing of the first input data signal DIN1 with other input data signals to generate a TDM output data stream of correctly positioned (in time) audio data that can be used by the transmit module 136 to generate an output data frame. In the example shown in FIG. 1, the first audio interface device 110a receives only the first input data signal DIN1, so the TDM output data stream generated by the TDM control module 134 comprises only data bits of the first input data signal DIN1, which can be positioned in a time slot of the output data frame that is reserved for audio data of the first audio channel.

The TDM output data stream output by the TDM control module 134 is received by the transmit module 136, which combines it with the clock signal output by the second clock generation module 132 and other bits or symbols such as a frame start symbol and user data bits to generate a first output data frame, representing both the first input data signal DIN1 and the clock signal output by the second clock generation module 132, that can be output by the transmit module 136 over the digital audio interface.

In the example illustrated in FIG. 1, the asynchronous sample rate converter 140 is bypassed because a sample rate of the first input data signal DIN1 is identical to a sample rate of the output serial data stream, but in other examples in which the sample rate of the input data signal is different from the sample rate of the output serial data stream, the asynchronous sample rate converter 140 could be used to adjust the sample rate of the first input data signal DIN1 to correspond to a desired sample rate for the first output data frame.

The second audio interface device 110b receives the first output data frame output by the first audio interface device 110a, and may also receive a second input data signal DIN2. The second input data signal DIN2 may comprise digital audio data for a second audio channel, e.g. digital audio data received from a second ADC coupled to a second microphone.

The second audio interface device 110b recovers the master system clock signal and the first input data signal DIN1 from the first output data frame received from the first audio interface device 110a, using its receive module 124 and the clock and data recovery module 126. The recovered first input data signal DIN1 is stored in the FIFO 128, and the recovered clock signal is used as a master system clock SYSCLK signal for the second audio interface device 110b.

The master system clock SYSCLK signal is supplied to the second clock generation module 132 of the second audio interface device 110b, which in turn outputs a clock signal based on or derived from the master system clock SYSCLK to the transmit module 136 of the second audio interface device 110b. The master system clock SYSCLK is also supplied to the first clock generation module 122 of the second audio interface device 110b, which generates local frame synchronisation (FSYNC) and base clock (BCLK) signals for the second audio interface device 110b based on the recovered master system clock signal SYSCLK.

The FIFO 128 outputs the recovered first input data signal DIN1 to the TDM control module 134 of the second audio interface device 110b. The TDM control module 134 multiplexes the recovered first input data signal DIN1 with the received second input data signal DIN2 to generate a TDM output data stream of correctly positioned (in time) audio data that can be used output by the transmit module 136 of the second audio interface device 110b to generate a second output data frame. The TDM control module 134 of the second audio interface device 110b thus arranges the data signals such that the first input data signal DIN1 can be positioned in a time slot of the output data frame that is reserved for audio data of the first audio channel, and the second input data signal DIN2 can be positioned in a time slot of the output data frame that is reserved for audio data of the second audio channel.

The TDM output data stream output by the TDM control module 134 of the second audio interface device 110b is received by the transmit module 136 of the second audio interface device 110b, which combines it with the clock signal output by the second clock generation module 132 and other bits or symbols such as a frame start symbol and user data bits to generate a second output data frame, representing the first and second input data signals DIN1, DIN2 and the clock signal output by the second clock generation module 132, that can be output by the transmit module 136 over the digital audio interface to a downstream device (not shown in FIG. 1).

### SUMMARY

According to a first aspect, the invention provides an audio communication system comprising: a first audio device; and a second audio device coupled to the first audio device by a digital audio interface, wherein: the first audio device is configured to synchronise a frame start symbol of a first audio device output signal for transmission by the first audio device to the second audio device with a first frame synchronisation signal local to the first audio device; and the second audio device is configured to detect the frame start symbol of the first audio device output signal and synchronise a second frame synchronisation signal local to the second audio device to the first frame synchronisation signal based on detection of the frame start symbol.

The second audio device may be configured to generate the second frame synchronisation signal in response to detection of the frame start symbol.

The first audio device may be configured to output the frame start signal in response to detection of the first frame synchronisation signal.

The second audio device may be configured to align a local bit clock signal of the second audio device with the second frame synchronisation signal.

The first audio device may be configured to output data describing a position of the first audio device in a network of devices of the audio communication system in the first audio device output signal.

The first audio device may be configured to output the data describing the position of the transmitter in the network in a user data bit of the first audio device output signal.

The second audio device may be configured to determine its position in the network of devices based on the data describing the position of the first audio device in the network of devices received from the first audio device.

The second audio device may be configured to determine its position in a network of devices of the audio communication system based on a number of channels of audio data received from the first audio device in the first audio device output signal.

The first audio device may be configured to determine that it occupies a first position in a network of devices of the audio communication system based on receiving a signal containing no audio channels at an input audio interface of the first audio device.

The first audio device output signal may comprise a first audio device output frame comprising an audio channel containing a first audio sample from the first audio device.

The second audio device may be configured to receive the first audio device output frame and output a second audio device output frame comprising a first audio channel containing the first audio sample from the first audio device and a second audio channel containing a second audio sample from the second audio device.

The first audio device may be configured to acquire the audio sample for the first audio device in a first sample period.

The second audio device may be configured to acquire the audio sample for the second audio device in the first sample period.

The second audio device may be configured to: receive the first audio sample in the first audio device output signal; apply a delay to the second audio sample; and combine the received first audio sample with the delayed second audio sample to generate the second audio device output frame.

The delay applied to the second audio sample may be configured to compensate for a transmission delay of the first audio sample between the first audio device and the second audio device.

The delay applied to the second audio sample may be based on a position of the second audio device in a network of devices of the audio communication system and/or a number of audio channels output by the first and/or second audio device.

The delay applied to the second audio sample may correspond to a duration of an integer number of first audio device output frames.

The audio interface may comprise an Alesis Digital Audio Tape (ADAT), a Sony/Philips Digital Interface (S/PDIF) interface or an AES3 Digital Interface.

According to a second aspect, the invention provides an audio device for an audio communication system, wherein the audio device is configured to output an output signal containing audio data to a further audio device coupled to a digital interface of the audio device, wherein the audio device is configured to synchronise a frame start symbol of the output signal with a local frame synchronisation signal of the audio device.

According to a third aspect, the invention provides an integrated circuit comprising the audio device of the second aspect.

According to a fourth aspect, the invention provides a host device comprising the audio device of the second aspect, wherein the host device comprises a laptop, notebook, netbook or tablet computer, a gaming device, a games console, a controller for a games console, a virtual reality (VR) or augmented reality (AR) device, a mobile telephone, a portable audio player, a portable device, an audio device, as an audio receiver, an audio mixer, an audio mixing desk, an accessory device for use with a laptop, notebook, netbook or tablet computer, a gaming device, a games console a VR or AR device, a mobile telephone, a portable audio player or other portable device.

According to a fifth aspect, the invention provides an audio communication system comprising a plurality of audio devices coupled in a daisy-chain network, wherein the plurality of audio devices comprises a primary audio device and a set of secondary audio devices, wherein each secondary audio device is configured to: receive a data frame from an upstream audio device of the plurality of audio devices; and determine its own position in the daisy-chain network based on: data in the received data frame; or a number of channels of audio data contained in the received data frame.

According to a sixth aspect, the invention provides an audio device for an audio communication system comprising a network of audio devices, wherein the audio device is configured to: receive a data frame from an upstream audio device of the network of audio devices; and determine its own position in the network of audio devices based on: data in the received data frame; or a number of channels of audio data contained in the received data frame.

According to a seventh aspect, the invention provides an audio communication system comprising a plurality of audio devices coupled in a daisy chain network, wherein the plurality of audio devices comprises a primary audio device and a set of secondary audio devices, wherein each secondary audio device is configured to: receive a data frame from an upstream audio device of the plurality of audio devices, wherein the received data frame contains a first audio sample acquired by the upstream audio device in a first sample period; acquire a second audio sample from the secondary audio device in the first sample period; delay the acquired audio second audio sample; and combine the received first audio sample with the delayed second audio sample to generate an output data frame containing the received first audio sample and the acquired second audio sample.

According to an eighth aspect, the invention provides an audio device for an audio communication system comprising a network of audio devices, wherein the audio device is configured to: receive a data frame from an upstream audio device of the network of audio devices wherein the received data frame contains a first audio sample acquired by the upstream audio device in a first sample period; acquire a second audio sample from the audio device in the first sample period; delay the acquired audio second audio sample; and combine the received first audio sample with the delayed second audio sample to generate an output data frame containing the received first audio sample and the acquired second audio sample.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the invention will now be described, strictly by way of example only, with reference to the accompanying drawings, of which:

FIG. 1 is a schematic representation of a configuration of two audio interface devices that are frequency locked;

FIG. 2 is a schematic representation of an audio communication system according to the present disclosure;

FIG. 3 is a schematic representation of a system comprising a plurality of audio devices coupled together in a daisy-chain configuration to transmit audio data frames to a downstream device;

FIG. 4 is a schematic diagram illustrating frames received by audio devices that are coupled in a daisy-chain configuration of the kind shown in FIG. 3; and

FIG. 5 is a schematic representation of a system comprising a plurality of stereo audio devices coupled together in a stereo-mode daisy-chain configuration to transmit audio data frames to a downstream device.

### DETAILED DESCRIPTION

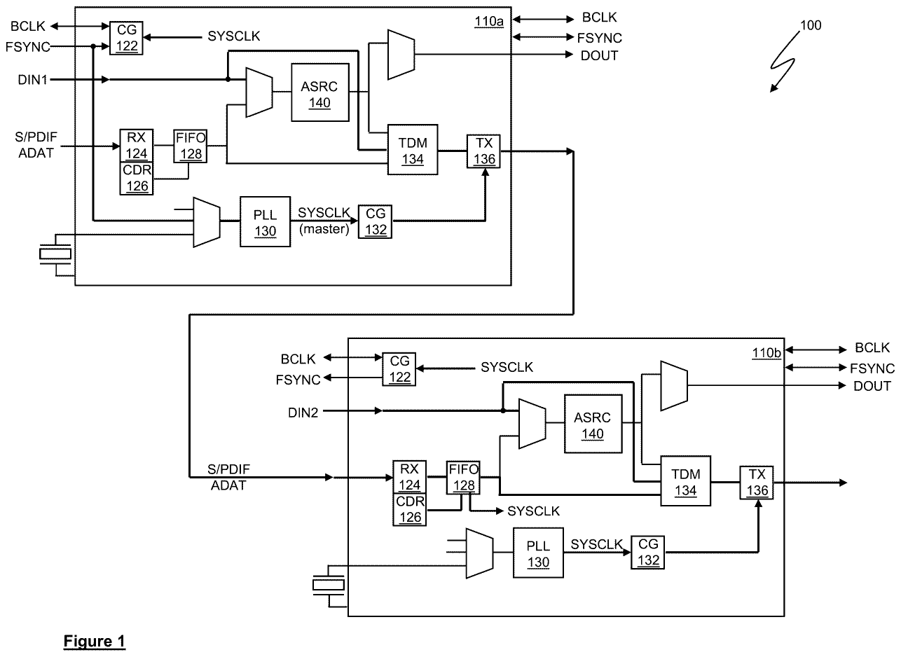

In the example illustrated in FIG. 1, a frequency of the base clock signal BCLK of the first audio interface device 110a is identical to a frequency of the base clock signal BCLK of the second audio interface device 110b, such that the first audio interface device 110a and the second audio interface device 110b are frequency locked, but the frame synchronisation signals FSYNC of the first and second audio interface devices 110a, 110b cannot be synchronised.

The frame synchronisation signal FSYNC indicates the phase of audio sampling in analog to digital converters (ADCs) and digital to analog converters (DACs) that are coupled to the audio interface devices 110a, 110b. It is desirable for ADCs and DACs in different parts of a digital audio system all to have phase-aligned FSYNC signals, to avoid phase errors in captured and reproduced multi-channel audio.

It is also desirable in high-fidelity audio systems to provide frequency locking along with frame and sample alignment across multiple networked devices.

The present disclosure proposes a communications system in which phase alignment can be performed between devices in the system by communicating frame synchronisation information using a frame start symbol of an interface between devices.

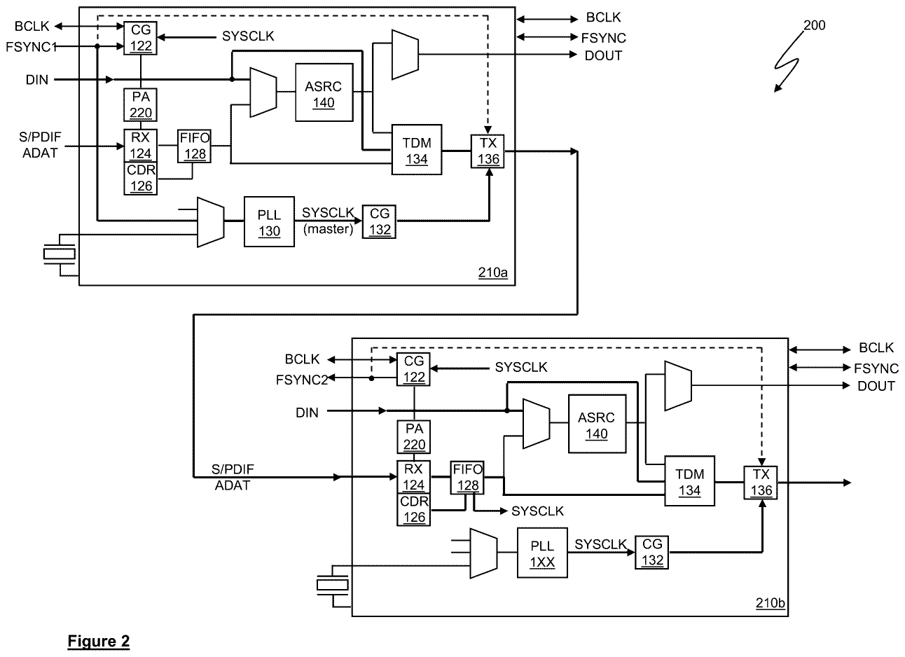

FIG. 2 is a schematic representation of an audio communication system according to the present disclosure.

The audio communication system, shown generally at 200 in FIG. 2, includes a first device 210a and a second device 210b coupled together by a digital audio interface such as an ADAT or S/PDIF interface. In the system 200, the first device 210a is configured as a transmitting device to transmit digital audio data to the second device 210b over the digital audio interface. The first and second devices 210a, 210b may be audio ICs, for example.

The first and second devices 210a, 210b each include a first clock generation module 122, a receiver module 124, a clock and data recovery module 126, a first-in-first out buffer (FIFO) 128, a phase-locked loop 130, a second clock generation module 132, a time division multiplexing (TDM) control module 134, a transmit module 136 and an asynchronous sample rate converter 140. These elements perform the same functions as the corresponding elements of the system 100 of FIG. 1.

The first and second devices 210a, 210b differ from the first and second audio interface devices 110a, 110b of the system 100 of FIG. 1 in that they each include a phase alignment module 220.

In operation of the first device 210a, a first output data frame is generated by the first device 210a as described above with reference to the first audio interface device 110a of FIG. 1a.A frame start symbol of the first output data frame generated by the first device 210a for transmission over the digital audio interface is synchronised (e.g. by the transmit module 136) with a local frame synchronisation signal FSYNC1 of the first device 210a, as indicated by the dashed arrow in FIG. 2. For example, the transmit module 136 may output a frame start symbol of the first output data frame in response to detecting an edge (e.g. a rising edge or a falling edge) of the local frame synchronisation signal FSYNC1 of the first device 210a. By synchronising the frame start symbol of the output data frame to the local frame synchronisation signal FSYNC1 of the first device 210a, the first device 210a can signal the phase of audio sampling to the second device 210b, to enable phase alignment between the first device 210a and the second device 210b.

In operation of the second device 210b, the phase alignment module 220 is operative to align a local frame synchronisation signal FSYNC2 of the second device 210b with the local frame synchronisation signal FSYNC1 of the first device 210a, based on detection of the start symbol received by the second device 210b in the first output data frame output by the first device 210a.

In response to detection of the frame start symbol in the first output data frame received from the first device 210a (e.g. in response to detection of a rising edge or a falling edge of a pulse of the frame start symbol in the received first output data frame), the phase alignment module 220 of the second device 210b outputs a local frame synchronisation signal FSYNC2 for the second device 210b. In this way, the local frame synchronisation signal FSYNC2 for the second device 210b can be synchronised with the local frame synchronisation signal FSYNC1 of the first device 210a.

In operation of the second device 210b, a second output data frame is generated by the second device 210b as described above with reference to the second audio interface device 110b of FIG. 1. A frame start symbol of the second output data frame generated by the second device 210b for transmission over the digital audio interface is synchronised (e.g. by the transmit module 136 of the second device 210b, in the manner described above) with the local frame synchronisation signal FSYNC2 for the second device 210b. In this way, the second device 210b can signal the phase of audio sampling to a further device (not shown in FIG. 2) coupled to the audio interface downstream of the second device 210b, to enable phase alignment between the second device 210b and the further downstream device.

As will be apparent from the foregoing discussion, synchronising the frame start signal of an output data frame output by a device (e.g. the first device 210a or the second device 210b) with a local frame synchronisation signal of that device enables alignment of the local frame synchronisation signals of all the devices in a daisy-chained string of devices that are coupled to each other using a digital audio interface. This helps to avoid phase errors in captured and reproduced multi-channel audio.

In addition to synchronising the local frame synchronisation signal FSYNC2 of the second device 210b with the local frame synchronisation signal FSYNC1 of the first device 210a, the second device 210b may also be configured to perform phase alignment between its local frame synchronisation signal FSYNC2 and its base clock signal BCLK, for example using the techniques such as those described in U.S. patent application Ser. No. 18/909,479 and Ser. No. 19/296,151, the contents of which are incorporated by reference herein.

In applications in which a plurality of audio devices are coupled together in a daisy-chain configuration to transmit audio data frames over a serial digital audio interface to a downstream device for processing, it is desirable to align audio samples from each of the audio devices in time, to prevent undesirable artefacts that may arise if the audio samples from the plurality of devices are not aligned in time.

However, serial-to-parallel and parallel-to-serial conversion that may occur within the audio devices can give rise to inter-sample delay between samples from each of the audio devices. The present disclosure proposes an audio communication system that can mitigate or compensate for such inter-sample delay.

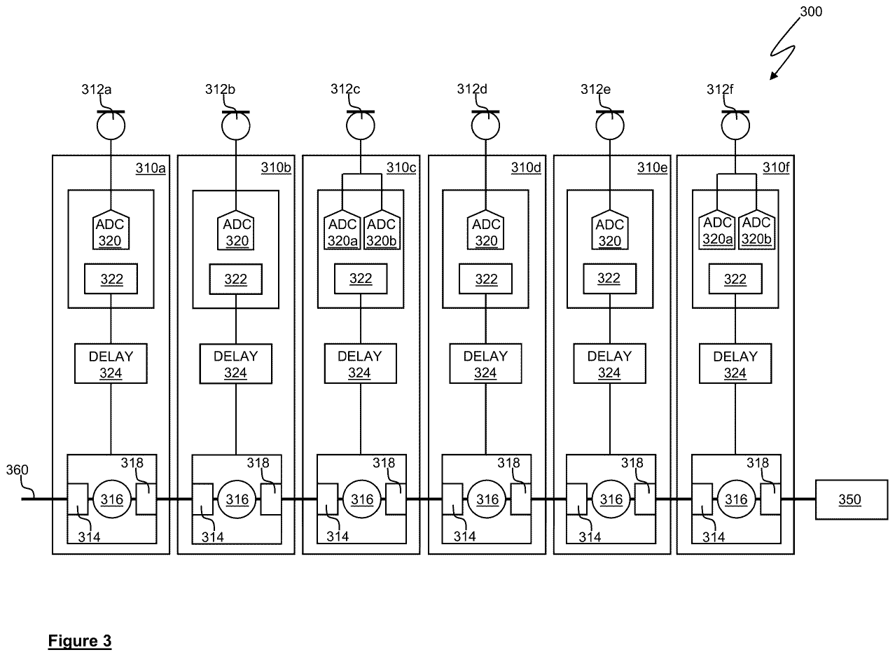

FIG. 3 is a schematic representation of a system comprising a plurality of audio devices coupled together in a daisy-chain configuration to transmit audio data frames to a downstream device.

In the system shown generally at 300 in FIG. 3, first to sixth audio devices 310a-310f are coupled together via digital audio interfaces such as ADAT or S/PDIF interfaces in a daisy-chain configuration, to transmit digital audio data to a downstream endpoint device 350, which may comprise, for example, a digital signal processor (DSP). The first audio device 310a may be a primary audio device, and the second to sixth audio devices 310b-310f may constitute a set of secondary audio devices. It is to be appreciated that a set of secondary audio devices may comprise one or more secondary audio devices.

For example, an output digital audio interface connection of the first audio device 310a is coupled to an input digital audio interface of the second audio device 310b, an output digital audio interface of the second audio device 312b is coupled to an input digital audio input interface of the third audio device 312c and so on. The daisy-chained audio devices 310a-310f thus form a digital audio network, represented by line 360 in FIG. 3. The audio devices 310a-310f may be devices of the kind described above with reference to FIG. 2.

In the example system 300 of FIG. 3, each of the first to sixth audio devices 310a-310f is configured to receive an analog output signal from a respective audio input transducer 312a-312f such as a microphone, and to output data frames representing audio data received from the audio input transducer 312a-312f to the next audio device in the daisy-chain.

Each audio device 310a-310f includes a serial-to-parallel converter 314 configured to convert serial data received from an immediately upstream device in the daisy-chain into parallel data for processing by the audio device. An output of the serial-to-parallel converter 314 is coupled to an input of a TDM control module 316 (which may be a TDM control module of the kind described above with reference to FIGS. 1 and 2). An output of the TDM control module 316 is coupled to an input of a parallel-to serial converter 318, which is configured to convert parallel data output by the TDM control module 316 to serial data for onward transmission to the next audio device in the daisy-chain.

Each audio device 310a-310f also includes one or more ADCs 320 for converting an analog input signal received from its respective audio input transducer 312a-312f into a digital signal that can be output in a digital data frame by the audio device 310a-310f. In the example system 300 of FIG. 3, the first, second, fourth and fifth audio devices 310a, 310b, 310d, 310e are mono audio devices configured to receive mono analog audio signals from respective mono audio input transducers 312a, 312b, 312d, 312e. These audio devices thus each include a single ADC 320 for converting the analog signal received from the audio input transducer to a digital signal. In contrast, the third and sixth audio devices 310c, 310f are stereo audio devices configured to receive stereo (e.g. left and right channel) analog audio signals from respective stereo audio input transducers 312c, 312f. These audio devices thus each include first and second ADCs 320a, 320b for converting first and second analog signals received from the audio input transducers into first and second digital signals.

Each audio device 310a-310f also includes a phase alignment module 322 of the kind described above with reference to FIG. 2, for performing synchronisation of frame synchronisation signals in the manner described above with reference to FIG. 2.

Each audio device 310a-310f also includes a delay element 324, configured to apply a delay to the digital signal output by its ADC(s) 320 to compensate for a transmission delay in transmission of an audio sample between audio devices 310a-310f, as will be described in detail below.

Each audio device 310a-310f in the system 300 of FIG. 3 is configured to determine its position in the daisy-chain based on data received by the audio device. For example, each audio device 310a-310f may receive, in a data frame received from an upstream device in the daisy-chain, a data header or other encoded information describing the position of the upstream device in the daisy-chain. Additionally or alternatively, an audio device 310a-310f may be configured to determine its position within the daisy-chain of audio devices 310a-310f by analysing the received data frame to determine the number of audio channels encoded by upstream devices in the daisy-chain, thereby providing an indication of the device's position in the daisy-chain based on an effective channel location of that device. Each audio device 310a-310f may additionally be configured to encode information indicative of its own position in the daisy-chain into a data frame that is transmitted by that audio device to a downstream audio device. Such information can be used by downstream audio devices to determine their own positions in the daisy-chain network 360.

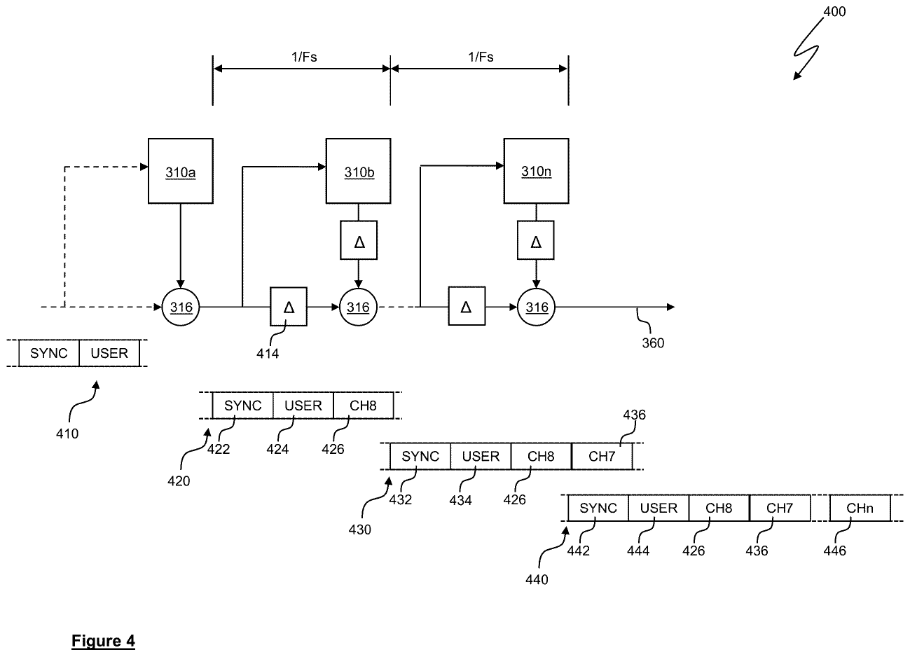

FIG. 4 is a schematic diagram illustrating frames received by audio devices that are coupled in a daisy-chain configuration of the kind shown in FIG. 3.

FIG. 4 shows a first audio device 310a, a second audio device 310b and an nth audio device 310n coupled in a daisy-chain configuration. The first audio device 310a may be a primary audio device, and the second to nth audio devices 310b-310n may constitute a set of secondary audio devices. Again, it is to be appreciated that a set of secondary audio devices may comprise one or more secondary audio devices.

Each of the audio devices 310a, 310b, 310n is configured to output data frames at a rate equal to a sampling rate Fs of the ADC(s) 320 (320a, 320b) of the audio devices 310a-310n. Thus, the first audio device 310a is configured to output a first audio device output data frame 420, the second audio device 320 is configured to output a second audio device output data frame 430, and the nth audio device is configured to output an nth audio device output data frame 440.

In the arrangement shown generally at 400 in FIG. 4, a first audio device 310a in the daisy-chain may receive an empty data frame 410, i.e. a data frame that contains no audio data. From this empty data frame 410, the first audio device 310a may determine or infer that it is the first device in the daisy-chain (i.e. that it occupies a position 1 in the daisy-chain, and may determine an expected audio configuration for the daisy-chain.

Alternatively, the first audio device 310a may be configured as the first device in the daisy-chain, and may generate a corresponding frame structure for transmission of audio data.

The first audio device 310a outputs a frame synchronisation symbol 422 (e.g. a frame start symbol of the kind discussed above with reference to FIG. 2), one or more user data bits 424 containing data identifying the position of the first audio device 310a in the daisy-chain, and an audio data channel 426 containing audio samples from the audio channel associated with the first audio device 310a (which in the example illustrated in FIG. 4 is channel 8). The TDM control module 316 of the first audio device 310a arranges the audio samples into the audio data channel 426, which is transmitted in a time slot N-1 of the output data frame 420, where N is the maximum number of audio devices allowed on the daisy-chain.

The second audio device 310b receives the first audio device output data frame 420 containing the frame synchronisation symbol 422, user data bit(s) 424 and audio data channel 426 from the first audio device 310a.

The second audio device 310b may determine its position in the daisy-chain based on the user data bit(s) 424 received from the first audio device 310a. In this example, the received user data bit(s) 424 include data indicating that the first audio device 310a is the first device in the daisy-chain. From these data, the second audio device 310b may determine that it is the second device in the daisy-chain.

Alternatively, the second audio device 310b may determine its position in the daisy chain based on the number of channels of audio data received. In this example, the second audio device 310b receives only one channel of audio data, namely the audio data channel 426. From this, the second audio device 310b may determine that it is the second device in the daisy-chain.

The second audio device 310b outputs a second audio device output data frame 430 containing a frame synchronisation symbol 432 (e.g. a frame start symbol of the kind discussed above with reference to FIG. 2), one or more user data bit(s) 434 containing data identifying the position of the second audio device 310b in the daisy-chain, an audio data channel 426 corresponding to the audio data channel 426 received from the first audio device 310a, and an audio data channel 434 containing audio samples from the audio channel associated with the second audio device 310b (which in the example illustrated in FIG. 4 is channel 7). The TDM control module 316 of the second device 310b arranges the audio samples such that the audio data channel 424 from the first device 310a is transmitted in time slot N-1 in the data frame 430 and the audio data channel 434 from the second device is transmitted in a time slot N-2 of the data frame 430, where N is the maximum number of audio devices allowed on the daisy-chain.

More generally, an nth audio device 310n in the daisy-chain receives an output data frame 430 containing a frame synchronisation symbol 432, user data bit(s) 434 and audio data channels 426, 436 from an (n-1)th audio device of the daisy-chain. In the example illustrated in FIG. 4, the nth device 310n receives the output data frame 430 from the second audio device 310b.

The nth audio device 310n may determine its position in the daisy-chain based on the data in the user data bit(s) 434 received from the (n-1)th device. In the example shown in FIG. 4, the received user data bit(s) 434 include data indicating that the second audio device 310b is the second device in the daisy-chain. From these data, the nth audio device 310n in the example illustrated in FIG. 4 may determine that it is the third device in the daisy-chain.

Alternatively, the nth audio device 310n may determine its position in the daisy chain based on the number of channels of audio data received. In this example, the nth audio device 310n receives only two channels of audio data, namely audio data channels 426 and 436. From this, the nth audio device 310n in the example illustrated in FIG. 4 may determine that it is the third device in the daisy-chain.

The nth audio device 310n outputs a data frame 440 containing a synchronisation symbol 442 (e.g. a frame start symbol of the kind discussed above with reference to FIG. 2), user data bit(s) 444 containing data identifying the position of the nth device 310n in the daisy-chain, audio data channels corresponding to the audio data channels received from the (n-1)th audio device (audio data channels 426, 436 corresponding to those received from the second audio device 310b, in the example illustrated in FIG. 4), and an audio data channel 446 containing audio samples from the audio channel associated with the nth audio device 310n (which in the example illustrated in FIG. 4 is channel n). The TDM control module 316 of the nth device 310n arranges the audio samples such that the audio data channel 426 is transmitted in slot N-1, the audio data channel 436 is transmitted in slot N-2, and the audio data channel 446 is transmitted in slot N-n, where N is the maximum number of audio devices allowed on the daisy-chain.

Referring again to FIG. 3, the audio input transducers 312a-312f operate in parallel to simultaneously capture sound from different sources, e.g. different instruments or vocalists in a live performance application. The audio devices 310a-310f are coupled in series via their digital audio interfaces, and include serial-to-parallel and parallel-to-serial converters 314, 318. As noted above, the serial-to-parallel and parallel-to-serial converters 314, 318 of the audio devices 310a-310f may introduce an inter-sample delay between the audio samples transmitted in audio data frames by the audio devices 310a-310f.

For example, in the system 300 of FIG. 3, the audio input transducers 312a-312f capture sound simultaneously. The ADCs 320 of the audio devices 310a-310f sample the analog outputs of the audio input transducers 312a-312f at a sampling frequency Fs, such that a new audio sample is output by the ADC 320 of each audio device 310a-310f every 1/Fs seconds.

Thus, in a first sample period Ts1, the ADC 320 of the first audio device 310a samples the analog output signal output by the audio input transducer 312a to generate an audio sample suitable for output in an audio data channel of a data frame output by the first audio device 310a. The ADCs of each of the other audio devices 310b-310f also sample the analog signals output by their respective audio input transducers 312b-312f to generate audio samples suitable for output in respective audio data channels of data frames that they output.

However, as noted above, as these audio samples are transmitted along the daisy-chain by the audio devices 310a-310f, sample misalignment can arise due to transmission delay introduced by the serial-to-parallel and parallel-to serial converters 314, 318 of the audio devices 310a-310f.

For example, in transmitting a first output data frame 420 including an audio data channel 426 containing the audio sample generated by the first audio device 310a in the first sample period Ts1 from the first audio device 310a to the second audio device 310b, the parallel-to-serial converter 318 of the first audio device 310a and the serial-to-parallel converter 314 of the second audio device 310b introduce a transmission delay Δ (represented by delay 414 in FIG. 4) to the audio sample contained in the audio data channel 426. Thus, the audio sample acquired by the first audio device 310a in the first sample period Ts1 does not reach the TDM control module 316 of the second audio device 310b until after an audio sample acquired by the second audio device 310a in the first sample period Ts1.

Put another way, when the audio sample acquired by the first audio device 310a in the first sample period Ts1 reaches the TDM control module 316 of the second audio device 310b, it is too late for that audio sample to be included in an output data frame with the audio sample acquired by the second audio device 310b in the first sample period Ts1.

However, if the audio sample acquired by the first audio device 310a in the first sample period Ts1 were included in an output data frame of the second audio device 310b when the audio sample acquired by the first audio device 310a in the first sample period Ts1 was available to the TDM control module 316 of the second audio device 310b, the output data frame of the second audio device 310b would also include an audio sample acquired by the second audio device 310b in a sample period later than the first sample period Ts1. Thus, the audio sample from the second audio device 310b contained in such an output data frame would be from a different sampling period than the audio sample from the first audio device 310a contained in that output data frame, i.e. the samples from the first and second audio devices 310a, 310b would be misaligned in time.

To mitigate this problem of sample misalignment, the delay element 324 of the second audio device 310b may be configured to apply a delay of a duration corresponding to that of one output data frame to its audio samples, such that, for example, the audio sample for the first sample period Ts1 are not supplied to the TDM control module 316 of the second audio device 310b until after the second audio device 310b has output a first output data frame. By delaying audio samples in this way, the audio sample acquired by the second audio device 310b in the first sample period Ts1 can be included in an output data frame of the second audio device 310b at a later time, when the audio sample from the first audio device 310a for the first sampling period Ts1 has been received by the TDM control module 316 of the second audio device 310b and thus can be included, with the audio sample acquired by the second audio device 310b in the first sample period Ts1, in an output data frame of the second audio device 310b. In this way, it can be ensured that the audio sample from the first audio device 310a and the audio sample from the second audio device 310b contained in the output data frame of the second audio device 310b were acquired in the same sample period, thus obviating the problem of sample misalignment.

As will be appreciated by those of ordinary skill in the art, the transmission delay introduced by the parallel-to-serial and serial to parallel converters 318, 314 of the audio devices 310a-310f is cumulative, such that for audio devices towards the end of the daisy-chain, the delay is greater than for audio devices towards the beginning of the daisy chain. Thus, to mitigate the risk of sample misalignment between audio devices, each audio device 310a-310f may be configured to apply a delay based on its position in the daisy chain to its audio samples. Thus, for example, the delay element 324 of the first audio device 310a may be configured to apply no delay to the audio samples of the first audio device, the delay element 324 of the second audio device 310b may be configured to apply a delay corresponding to one data frame, and the delay element 324 of the nth audio device 310n may be configured to apply a delay corresponding to (n-1) data frames.

As each audio device 310a-310f applies a suitable delay to its own audio sample before combining its audio sample with those received from the upstream device(s) in its output data frame, a final output data frame can be generated by the last audio device in the daisy-chain (the sixth audio device 310f, in the example of FIG. 3) containing the audio samples of all the audio devices 310a-310f positioned in the correct time slots within the output data frame, and without any sample misalignment. This final output data frame may then be output to the downstream endpoint device 350 which may process of the audio samples of each of the audio device 310a-310f.

In a daisy-chain in which each audio device is configured as a mono device, the delay element 324 of each audio device can apply a delay corresponding to (n-1) data frames to the audio samples of an audio device (where n is the position in the daisy-chain of the audio device) to mitigate sample misalignment. However, in a mixed-mode daisy-chain of the kind shown in FIG. 3, this approach may not fully mitigate sample misalignment, because the audio samples output by mono devices (e.g. the first, second, fourth and fifth audio devices 310a, 310b, 310d, 310e of FIG. 3) occupy one channel position in an output data frame, whereas the audio samples output by stereo devices (e.g. the third and sixth audio devices 310c, 310f of FIG. 3) occupy two consecutive channels in the output data frame.

Thus, in a mixed-mode daisy-chain of the kind shown in FIG. 3, the delay element 324 of each audio device 310a-310f may be configured to apply a delay based on the number of audio channels that are present in an output data frame output by that audio device. Alternatively, the delay element of each audio device 310a-310f may be configured to apply a delay based on the number of audio channels that are present in an output data frame output by the audio device immediately upstream in the daisy-chain.

For example, in the mixed-mode daisy-chain shown in FIG. 3, an output data frame output by the first audio device 310a has a single audio channel, and the delay element 324 of the first audio device 310a is configured to apply no delay. An output data frame output by the second audio device 310b has two audio channels (a first channel containing the audio sample from the first audio device 310a and a second channel containing the audio sample from the second audio device 310b), and the delay element 324 of the second audio device 310b is configured to apply a delay corresponding to one data frame.

An output data frame output by the third audio device 310c (which is a stereo device) has four audio channels (one each from the mono first and second audio devices 310a, 310b and two from the stereo third audio device 310c), and the delay element 324 of the third audio device 310c is configured to apply a delay corresponding to three data frames.

An output data frame output by the fourth audio device 310d (which is a mono device) has five audio channels (one each from the mono first, second and fourth audio devices 310a, 310b, 310d and two from the stereo third audio device 310c), and the delay element 324 of the fourth audio device 310d is configured to apply a delay corresponding to four data frames.

An output data frame output by the fifth audio device 310e (which is a mono device) has six audio channels (one each from the mono first, second, fourth and fifth audio devices 310a, 310b, 310d, 310e and two from the stereo third audio device 310c), and the delay element 324 of the fifth audio device 310e is configured to apply a delay corresponding to five data frames.

An output data frame output by the sixth audio device 310f (which is a stereo device) has eight audio channels (one each from the mono first, second, fourth and fifth audio devices 310a, 310b, 310d, 310e and two each from the stereo third and sixth audio devices 310c, 310f), and the delay element 324 of the sixth audio device 310f is configured to apply a delay corresponding to seven data frames.

Thus, the delay applied by the delay element 324 of an audio device in a mixed-mode daisy-chain may be dependent on the position of the device in the daisy-chain and/or the number of audio channels that device provides. In general, the delay element 324 of an audio device in a mixed-mode system may be configured to apply a delay corresponding to c-1 data frames, where c is the number of audio channels that are present in an output data frame of the audio device.

As noted above, FIG. 3 shows a system 300 configured as a mixed mode system, comprising both mono devices (the first, second, fourth and fifth audio devices 310a, 310b, 310d, 310e) and stereo devices (the third and sixth audio devices 310c, 310f). In such a configuration, each audio device 310a-310f is configured as a mono or stereo device and can then determine its own position in the daisy-chain and the slot(s) to use for its audio data based on the user data frame it receives, as described above.

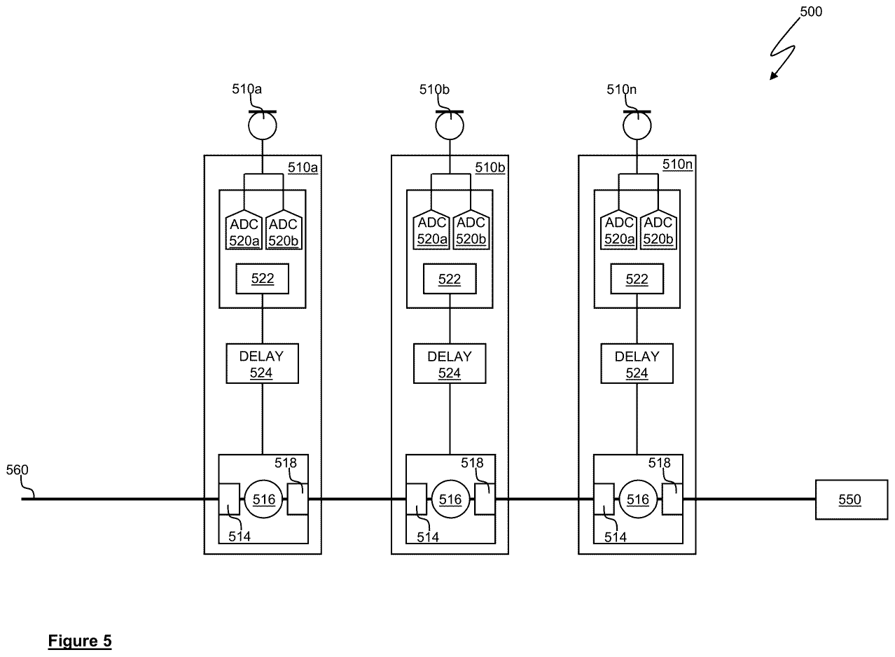

FIG. 5 is a schematic representation of a system comprising a plurality of stereo audio devices coupled together in a stereo-mode daisy-chain configuration to transmit audio data frames to a downstream device.

In the system shown generally at 500 in FIG. 5, first to nth audio devices 510a-510n are coupled together via digital audio interfaces such as a S/PDIF or ADAT interfaces in a daisy-chain configuration to transmit digital data to a downstream device 550, which may comprise, for example, a digital signal processor (DSP), over a digital audio network 560. Thus, for example, an output digital audio interface connection of the first audio device 510a is coupled to an input digital audio interface connection of the second audio device 510b, and an output digital audio interface of an (n-1)th audio device is coupled to an input digital audio input interface of the nth audio device 512n. The audio devices 510a-510n may be devices of the kind described above with reference to FIG. 2. The first audio device 510a may be a primary audio device, whilst the second to nth audio devices 510b-501n may constitute a set of secondary audio devices. It is to be understood that a set of secondary audio devices may comprise one or more secondary audio devices.

In the example system 500 of FIG. 5, each of the first to nth audio devices 510a-510n is configured to receive an analog output signal from a respective audio input transducer 512a-312n such as a microphone, and to output a digital data stream comprising digital data frames representing audio data received from the audio input transducer 512a-512n to the digital audio network 560.

Each audio device 510a-510n includes a serial-to-parallel converter 514 configured to convert serial data received from the digital audio network 560 into parallel data for processing by the audio device. An output of the serial-to-parallel converter 514 is coupled to an input of a TDM control module 516 (which may be a TDM control module of the kind described above with reference to FIGS. 1 and 2). An output of the TDM control module 516 is coupled to an input of a parallel-to serial converter 518, which is configured to convert parallel data output by the TDM control module 516 to serial data for onward transmission to the next audio device in the daisy-chain over the digital audio network 560.

Each audio device 510a-510n also includes first and second ADCs 520a, 520b for converting first and second analog signals received from its respective audio input transducer 512a-512n into first and second digital signals, each representing a channel of audio data.

Each audio device 510a-510n also includes a phase alignment module 522 of the kind described above with reference to FIG. 2, for performing synchronisation of frame synchronisation signals in the manner described above with reference to FIG. 2.

Each audio device 510a-510n also includes a delay element 524, configured to apply a delay to the audio samples output by the ADC 520, to compensate for inter-sample delay and thereby eliminate or reduce sample misalignment between samples output by the different audio devices 510a-510n.

In a stereo-mode system of the kind shown in FIG. 5, only the first audio device 510a needs to be configured as a stereo device, and each downstream device 510b-510n can determine its mode and the timeslots of an output data frame to use for its audio data automatically, e.g. based on the information contained in user data bits received from the device immediately upstream of it, or based on the number of channels of audio data that are present in the audio data frames received from the device immediately upstream of it.

The delay element 524 of each audio device 510a-510c may be configured to apply an appropriate delay to the audio samples output by its ADCs 520a, 520b to compensate for delay introduced by its serial-to-parallel converter 514 and the parallel-to serial converter 518 of the immediately upstream audio device.

In a stereo-mode system of the kind shown in FIG. 5, two channels of audio samples (e.g. a first channel of audio samples output by the ADC 520a and a second channel of audio samples output by the ADC 520b) may be combined in a single stereo channel in an output data frame, with the number of such channels available in the system being reduced accordingly.

Thus, in a stereo-mode system of the kind shown in FIG. 5, the delay element 524 of each audio device 510a-510n may be configured to apply a delay corresponding to (n-1) data frames, where n is position of the device in the daisy chain.

As will be apparent from the foregoing discussion, each audio device of the secondary sets of audio devices in the daisy chain is configured to apply a delay corresponding to the duration of an integer number of data frames to its own audio sample to compensate for the transmission delay in the audio sample(s) transmitted by the upstream audio device(s) in their respective output data frames.

The present disclosure provides an audio communication system in which a plurality of audio devices can be coupled together using a digital audio interface such as S/PDIF or ADAT. The audio communication system of the present disclosure permits high fidelity (Hi-Fi) audio transmission over asynchronous audio interfaces, and can reduce clock jitter and phase misalignment across multiple connected devices.

The present disclosure proposes a clocking and alignment scheme allowing synchronised audio transmission with minimized jitter. The use of frequency-and phase-locking between devices ensures frequency synchronization and frame alignment by aligning frame start symbols and employing phase adjustments.

Audio devices of the system are arranged to determine their position in the audio chain, manage data slots accordingly, and adjust timing based on whether they operate in stereo or mono mode. By reducing jitter and providing phase alignment, the architecture enables high-quality, click-free audio suitable for HiFi systems without detailed external clock requirements.

The audio devices 310a-310n and 510a-510n of the present disclosure may be implemented in integrated circuitry, e.g. in single integrated circuits. Alternative, the audio devices 310a-310n and 510a-510n of the present disclosure may be implemented using software executed by appropriate processing circuitry, e.g. a digital signal processor (DSP), general-purpose microprocessor, microcontroller or the like.

The described systems may be utilised for the transmission of audio between nodes of a communication system. The different nodes may allow for the output of transmitted audio and/or receiving recorded audio, e.g. using microphones or other suitable transducers.

An audio device of the kind described above with reference to the accompanying drawings may be incorporated in a host device such as a laptop, notebook, netbook or tablet computer, a gaming device such as a games console or a controller for a games console, a virtual reality (VR) or augmented reality (AR) device, a mobile telephone, a portable audio player or some other portable device, an audio device such as an audio receiver audio mixer or mixing desk, or may be incorporated in an accessory device for use with a laptop, notebook, netbook or tablet computer, a gaming device, a VR or AR device, a mobile telephone, a portable audio player or other portable device.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog TM or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

The following paragraphs describe aspects of the present disclosure.

The present disclosure provides a system and method for a communications system, preferably a communications bus for an audio system.

The present disclosure provides a system and method for an audio communications network, for example a serial audio network such as an ADAT or S/PDIF network, preferably for a daisy-chain network configuration, wherein the system and method is configured such that: at a transmitter, a frame start symbol of a data frame to be transmitted is aligned with a locally-generated frame synchronization signal; and at a receiver, a local frame synchronization signal is generated based on a frame start symbol of a received data frame.

Such a system allows for the phase alignment between devices of the network, as the frame synchronization of individual devices can be communicated to and recovered from the data communicated between devices.

There is further provided a system and method for an audio communications network, for example a serial audio network such as an ADAT or S/PDIF network, wherein the system and method is configured such that in a daisy-chain configuration, a device is operable to: determine the device position in the network, and compensate for device-related latency in the daisy-chain network by delaying data to be transmitted by the device based on the determined device position.

The device is operable to dynamically determine a sample delay to be applied to the data to be transmitted by the device, wherein the sample delay is based on the location of the device within the daisy-chain network.

The sample delay may also be determined based on the configuration of the device itself, e.g. whether the device is operating in a mono or stereo mode may determine the delay to be applied to the data to be transmitted.

The sample delay may be based on the latency due to data conversion between serial and parallel configurations of data at the device.

The device may be configured to determine device position in the network based on: position information encoded in data received by the device, where the position information may describe the presence of upstream devices in the network; and/or channel information encoded in data received by the device, where the channel information may describe the number of audio channels encoded in the received data by upstream devices in the network.

The device may be configured to include information based on the device position in the network in the data to be transmitted.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. An audio communication system comprising:
a first audio device; and
a second audio device coupled to the first audio device by a digital audio interface, wherein:
the first audio device is configured to synchronise a frame start symbol of a first audio device output signal for transmission by the first audio device to the second audio device with a first frame synchronisation signal local to the first audio device; and
the second audio device is configured to detect the frame start symbol of the first audio device output signal and synchronise a second frame synchronisation signal local to the second audio device to the first frame synchronisation signal based on detection of the frame start symbol.

2. The audio communication system of claim 1, wherein the second audio device is configured to generate the second frame synchronisation signal in response to detection of the frame start symbol.

3. The audio communication system of claim 1, wherein the first audio device is configured to output the frame start signal in response to detection of the first frame synchronisation signal.

4. The audio communication system of claim 2, wherein the second audio device is configured to align a local bit clock signal of the second audio device with the second frame synchronisation signal.

5. The audio communication system of claim 1, wherein the first audio device is configured to output data describing a position of the first audio device in a network of devices of the audio communication system in the first audio device output signal.

6. The audio communication system of claim 5, wherein the first audio device is configured to output the data describing the position of the transmitter in the network in a user data bit of the first audio device output signal.

7. The audio communication system of claim 5, wherein the second audio device is configured to determine its position in the network of devices based on the data describing the position of the first audio device in the network of devices received from the first audio device.

8. The audio communication system of claim 1, wherein the second audio device is configured to determine its position in a network of devices of the audio communication system based on a number of channels of audio data received from the first audio device in the first audio device output signal.

9. The audio communication system of claim 1, wherein the first audio device is configured to determine that it occupies a first position in a network of devices of the audio communication system based on receiving a signal containing no audio channels at an input audio interface of the first audio device.

10. The audio communication system of claim 1, wherein the first audio device output signal comprises a first audio device output frame comprising an audio channel containing a first audio sample from the first audio device.

11. The audio communication system of claim 10, wherein the second audio device is configured to receive the first audio device output frame and output a second audio device output frame comprising a first audio channel containing the first audio sample from the first audio device and a second audio channel containing a second audio sample from the second audio device.

12. The audio communication system of claim 11, wherein:
the first audio device is configured to acquire the audio sample for the first audio device in a first sample period; and
the second audio device is configured to acquire the audio sample for the second audio device in the first sample period.

13. The audio communication system of claim 12, wherein the second audio device is configured to:
receive the first audio sample in the first audio device output signal;
apply a delay to the second audio sample; and
combine the received first audio sample with the delayed second audio sample to generate the second audio device output frame.

14. The audio communication system of claim 13, wherein the delay applied to the second audio sample is configured to compensate for a transmission delay of the first audio sample between the first audio device and the second audio device.

15. The audio communication system of claim 14, wherein the delay applied to the second audio sample is based on a position of the second audio device in a network of devices of the audio communication system and/or a number of audio channels output by the first and/or second audio device.

16. The audio communication system of claim 15, wherein the delay applied to the second audio sample corresponds to a duration of an integer number of first audio device output frames.

17. The audio communication system of claim 1, wherein the audio interface comprises an Alesis Digital Audio Tape (ADAT), a Sony/Philips Digital Interface (S/PDIF) interface or an AES3 Digital Interface.

18. An audio device for an audio communication system, wherein the audio device is configured to output an output signal containing audio data to a further audio device coupled to a digital interface of the audio device, wherein the audio device is configured to synchronise a frame start symbol of the output signal with a local frame synchronisation signal of the audio device.

19. An integrated circuit comprising the audio device of claim 18.

20. A host device comprising the audio device of claim 18, wherein the host device comprises a laptop, notebook, netbook or tablet computer, a gaming device, a games console, a controller for a games console, a virtual reality (VR) or augmented reality (AR) device, a mobile telephone, a portable audio player, a portable device, an audio device, as an audio receiver, an audio mixer, an audio mixing desk, an accessory device for use with a laptop, notebook, netbook or tablet computer, a gaming device, a games console a VR or AR device, a mobile telephone, a portable audio player or other portable device.

21. An audio communication system comprising a plurality of audio devices coupled in a daisy-chain network, wherein the plurality of audio devices comprises a primary audio device and a set of secondary audio devices, wherein each secondary audio device is configured to:
receive a data frame from an upstream audio device of the plurality of audio devices; and
determine its own position in the daisy-chain network based on:
data in the received data frame; or
a number of channels of audio data contained in the received data frame.

22. An audio device for an audio communication system comprising a network of audio devices, wherein the audio device is configured to:
receive a data frame from an upstream audio device of the network of audio devices; and
determine its own position in the network of audio devices based on:
data in the received data frame; or
a number of channels of audio data contained in the received data frame.

23. An audio communication system comprising a plurality of audio devices coupled in a daisy chain network, wherein the plurality of audio devices comprises a primary audio device and a set of secondary audio devices, wherein each secondary audio device is configured to:
receive a data frame from an upstream audio device of the plurality of audio devices, wherein the received data frame contains a first audio sample acquired by the upstream audio device in a first sample period;
acquire a second audio sample from the secondary audio device in the first sample period;
delay the acquired audio second audio sample; and
combine the received first audio sample with the delayed second audio sample to generate an output data frame containing the received first audio sample and the acquired second audio sample.

24. An audio device for an audio communication system comprising a network of audio devices, wherein the audio device is configured to:
receive a data frame from an upstream audio device of the network of audio devices wherein the received data frame contains a first audio sample acquired by the upstream audio device in a first sample period;
acquire a second audio sample from the audio device in the first sample period;
delay the acquired audio second audio sample; and
combine the received first audio sample with the delayed second audio sample to generate an output data frame containing the received first audio sample and the acquired second audio sample.
